(19) United States
(12) Patent Application Publication
(10) Pub. No.: US 2026/0338316 A1
(43) Pub. Date: Oct. 29, 2026

(54) PORTABLE UNLOCKING TRIPOD

(71) Applicant: Dongguan Lizhi Technology Co., Ltd., Dongguan (CN)

(72) Inventors: Zhihao LIANG, Dongguan (CN); Wangeng FENG, Dongguan (CN); Feng TANG, Dongguan (CN)

(73) Assignee: Dongguan Lizhi Technology Co., Ltd., Dongguan (CN)

(21) Appl. No.: 19/634,146

(22) Filed: Mar. 31, 2026

(30) Foreign Application Priority Data
Apr. 28, 2025 (CN) 2025208257262

(51) Int. Cl. F16M 11/14; F16M 11/04; F16M 11/38; G03B 17/56

(52) U.S. Cl. CPC F16M 11/14; F16M 11/041; G03B 17/561; F16M 11/38; F16M 2200/022

(57) ABSTRACT

The present application relates to the technical field of photographic equipment and discloses a portable unlocking tripod. The tripod includes a locking assembly and a mounting bracket; a mounting slot is provided at the top of the mounting bracket, and a limiting groove is provided in an inner side wall of the mounting bracket; the locking assembly includes a driving member, a sliding member, and a locking member; one end of the driving member is rotatably connected to the mounting bracket, the sliding member is slidably fitted in the mounting slot, and a part of the driving member abuts against the sliding member so as to press the sliding member; the locking member extends through the sliding member and is fixed in the mounting slot, and the sliding member is configured to lock the locking member; a limiting structure is provided on the side of the sliding member.

### CROSS-REFERENCE TO RELATED APPLICATIONS

The application claims priority to Chinese patent application No. 2025208257262, filed on Apr. 28, 2025, the entire contents of which are incorporated herein by reference.

### TECHNICAL FIELD

The present application relates to the technical field of photographic equipment, and in particular, to a portable unlocking tripod.

### BACKGROUND

In the field of photography, shooting scenarios and demands are highly diverse. Ranging from capturing vast landscape long shots and exquisite close-up details, to tracking moving objects in follow shots and presenting unique perspectives through rotational shooting during creation, all these scenarios place stringent requirements on camera tripods. To meet these complex requirements, most camera tripods on the market have the feature of swinging freely in multiple directions with their support points as the pivot, which facilitates flexible, creative shooting for photographers.

In long-duration static shooting scenarios, camera tripods must remain upright and fixed. Therefore, an upright locking device capable of conveniently switching between free swinging and upright locking is extremely critical. Moreover, photographic equipment mounted on the tripod head is prone to shaking and imbalance when switching shooting directions. Currently, most tripods on the market feature overly complicated locking device designs, with cumbersome unlocking and locking procedures that are difficult to complete in a single operation. This results in low working efficiency in scenarios that require frequent switching between free swinging and upright locking states.

### SUMMARY

The technical problem to be solved by the present application is to optimize the structure of existing tripods, thereby simplifying the locking and unlocking steps of the tripod and improving the working efficiency and ease of use.

To solve the above problem, the present application provides a portable unlocking tripod, comprising a locking assembly and a mounting bracket; a mounting slot is provided at the top of the mounting bracket, and a limiting groove is provided in an inner side wall of the mounting slot; the locking assembly comprises a driving member, a sliding member, and a locking member; one end of the driving member is rotatably connected to the mounting bracket, the sliding member is slidably fitted in the mounting slot, and a part of the driving member abuts against the sliding member so as to press the sliding member; the locking member extends through the sliding member and is fixed in the mounting slot, and the sliding member is configured to lock the locking member; a limiting structure is provided on the side of the sliding member, and when the tripod is in a locked state, the limiting structure is disengaged from the limiting groove; when the tripod is in an unlocked state, the limiting structure is snap-engaged and retained in the limiting groove.

Preferably, the tripod further comprises a torsion spring; an upright pillar is provided in the middle of the mounting slot, and the locking member is fixedly connected to the upright pillar; the sliding member is slidably fitted over the upright pillar in a vertical direction; the torsion spring is fitted over the exterior of the upright pillar, and both ends of the torsion spring abut against a bottom wall of the mounting slot and the sliding member, respectively.

Preferably, the sliding member comprises an upper portion and a boss portion that are integrally formed, and sliding grooves are formed through opposite sides of the upper portion; connecting shafts are protrudingly provided on both sides of the upright pillar corresponding to the sliding grooves, and the two connecting shafts extend through the two sliding grooves, respectively; each end of the driving member is fitted over one of the connecting shafts, and the driving member is rotatable about the connecting shafts; when the driving member is pressed, the driving member abuts against the boss portion.

Preferably, the limiting groove is L-shaped, and the limiting structure is protrudingly provided on an outer side wall of the boss portion; when the driving member is pressed, the limiting structure slides along a vertical end of the limiting groove and is snap-engaged and retained at a horizontal end of the limiting groove.

Preferably, the locking member comprises a ball and a sleeve; a bottom end of the ball extends through the sliding member and is fixed in the upright pillar, the sleeve is rotatably fitted over the exterior of the ball, and the top of the sliding member is configured to abut against the bottom of the sleeve.

Preferably, the tripod further comprises a pressing member and a first spring; both ends of the first spring abut against a bottom wall of the mounting slot and the sliding member, respectively; the limiting groove extends through a side wall of the mounting bracket; the pressing member is slidably retained in the limiting groove; the limiting structure is horizontally slidably provided on a side wall of the sliding member; a second spring is provided between the limiting structure and the sliding member; and the pressing member is configured to abut against the limiting structure.

Preferably, a connecting post is provided in the middle of the mounting slot, the locking member is fixedly connected to the connecting post, and the limiting groove extends through a side wall of the mounting bracket; an abutment bar is provided in the middle of the sliding member, and the abutment bar extends through the middle of the connecting post; the tripod further comprises a third spring, both ends of which abut against the bottom of the abutment bar and a bottom wall of the mounting slot, respectively; a first through slot is formed through a side wall of the connecting post, and one end of the driving member is rotatably connected to the connecting post; a second through slot is formed through one side of the sliding member, the other end of the driving member sequentially extends through the first through slot, the second through slot, and the limiting groove, and the driving member abuts against the top of the abutment bar to drive the sliding member to slide; one end of the limiting structure is movably retained in the limiting groove, and the other end of the limiting structure is slidably connected to the driving member.

Preferably, the limiting structure comprises a limiting block and a fourth spring; one end of the limiting block is provided with an I-shaped limiting portion and a relief groove, and the limiting portion is configured to abut against a groove wall of the limiting groove; the other end of the limiting block slidably extends through the driving member; the fourth spring is provided in the driving member, and both ends of the fourth spring abut against the limiting block and the driving member, respectively.

Preferably, guide slopes are provided on opposite sides of the limiting portion.

Compared with the prior art, the present application includes at least one of the following beneficial technical effects:

One end of the driving member is rotatably connected to the mounting bracket. When unlocking the tripod, a user may rotate the driving member downward to press the sliding member to slide vertically in the mounting slot, such that the top of the sliding member is disengaged from the bottom of the locking member. When the limiting structure on the side of the sliding member is snap-engaged in the limiting groove, the tripod is unlocked. When the tripod is in a locked state, the limiting structure on the side of the sliding member is disengaged from the limiting groove, such that the sliding member resets upward and abuts against and is retained at the bottom of the locking member. Compared with the complicated locking structure of a conventional tripod, the present application simplifies the manufacturing process and assembly procedure and reduces cost, thereby simplifying the locking and unlocking steps of the tripod and improving the working efficiency and ease of use.

### BRIEF DESCRIPTION OF DRAWINGS

To facilitate a clearer description of the technical solutions in the embodiments of the present application, a brief introduction is provided below to the accompanying drawings used in the description of the embodiments. It is obvious that the drawings described below represent some embodiments of the present application, and for those of ordinary skill in the art, other drawings may also be obtained based on these drawings without creative efforts.

FIG. 1 is a schematic diagram of the overall structure of the portable unlocking tripod according to Embodiment 1 of the present invention.

FIG. 2 is an exploded view of the portable unlocking tripod according to Embodiment 1 of the present invention.

FIG. 3 is a schematic structural diagram of the mounting bracket according to Embodiment 1 of the present invention.

FIG. 4 is an exploded view of the limiting structure and the pressing member according to Embodiment 2 of the present invention.

FIG. 5 is a sectional view of the portable unlocking tripod according to Embodiment 2 of the present invention.

FIG. 6 is a schematic diagram of the overall structure of the portable unlocking tripod according to Embodiment 3 of the present invention.

FIG. 7 is an exploded view of the portable unlocking tripod according to Embodiment 3 of the present invention.

FIG. 8 is a sectional view of the portable unlocking tripod according to Embodiment 3 of the present invention.

FIG. 9 is an exploded view of the driving member and the limiting structure according to Embodiment 3 of the present invention.

Description of the Reference Numerals: 1, locking assembly; 2, mounting bracket; 3, torsion spring; 4, pressing member; 5, third spring; 6, driving member; 7, sliding member; 8, locking member; 9, limiting structure; 10, upper portion; 11, boss portion; 12, abutment bar; 13, limiting block; 14, fourth spring; 15, limiting portion; 16, relief groove; 17, guide slope; 18, sliding groove; 19, ball; 20, sleeve; 21, mounting slot; 22, limiting groove; 23, upright pillar; 24, connecting post; 25, connecting shaft; 26, first through slot; 27, second spring; 28, second through slot; 29, first spring.

### DETAILED DESCRIPTION OF THE EMBODIMENTS

The technical solutions in the embodiments of the present application will be clearly and completely described below with reference to the accompanying drawings in the embodiments of the present application. Obviously, the described embodiments are part of the embodiments of the present application, rather than all of the embodiments. Based on the embodiments in the present application, all other embodiments obtained by those of ordinary skill in the art without creative effort shall fall within the scope of the present application.

It should be understood that when used in this specification and the appended claims, the terms “comprise” and “include” indicate the presence of described features, wholes, steps, operations, elements and/or components, but do not exclude the presence or addition of one or more of other features, wholes, steps, operations, elements, components, and/or sets thereof.

It should also be understood that the terms used in the specification of the present application are for the purpose of describing particular embodiments only and are not intended to limit the present application. As used in the specification and the appended claims of the present application, the singular forms “a”, “an”, and “the” are intended to include the plural forms, unless the context clearly indicates otherwise.

It should be further understood that the term “and/or” used in the specification and the appended claims of the present application refers to any and all possible combinations of one or more of the associated listed items, and includes these combinations.

### Embodiment 1

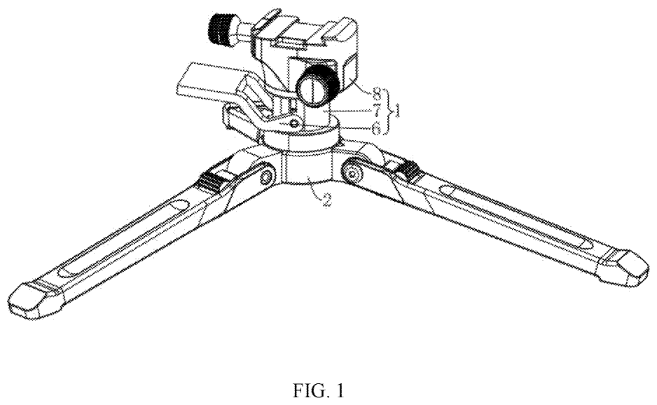

Referring to FIGS. 1 to 3, Embodiment 1 of the present application provides a portable unlocking tripod, which simplifies the structure of existing tripods. A user may quickly lock and unlock the tripod with only simple operations, thereby improving the ease of use of the tripod. The orientation description in the present application is made with the tripod in an upright state.

Specifically, the tripod includes a locking assembly 1 and a mounting bracket 2. A mounting slot 21 is provided at the top of the mounting bracket 2, and a limiting groove 22 is provided in an inner side wall of the mounting bracket 2. The locking assembly 1 includes a driving member 6, a sliding member 7, and a locking member 8. One end of the driving member 6 is rotatably connected to the mounting bracket 2, the sliding member 7 is slidably fitted in the mounting slot 21 in a vertical direction, and a part of the driving member 6 abuts against the sliding member 7 so as to press the sliding member 7. The locking member 8 extends through the slide member 7 and is fixed in the mounting slot 21, and the sliding member 7 is configured to lock the locking member 8. A limiting structure 9 is provided on the side of the sliding member 7. When the tripod is in a locked state, the limiting structure 9 is disengaged from the limiting groove 22; when the tripod is in an unlocked state, the limiting structure 9 is snap-engaged and retained in the limiting groove 22.

Here, one end of the driving member 6 is rotatably connected to the mounting bracket 2. When unlocking the tripod, a user may press down the driving member 6 to press the sliding member 7, such that the sliding member 7 slides vertically in the mounting slot 21, and the top of the sliding member 7 is disengaged from the bottom of the locking member 8. When the limiting structure 9 on the side of the sliding member 7 slides along the limiting groove 22 and is snap-engaged and retained in the limiting groove 22, the tripod is unlocked. When the tripod is in a locked state, the limiting structure 9 on the side of the sliding member 7 is disengaged from the limiting groove 22, such that the sliding member 7 resets upward and abuts against and is retained at the bottom of the locking member 8. Compared with the complicated locking structure of a conventional tripod, the present application greatly simplifies the manufacturing process and assembly procedure and reduces cost, thereby simplifying the locking and unlocking steps of the tripod and improving the working efficiency and ease of use.

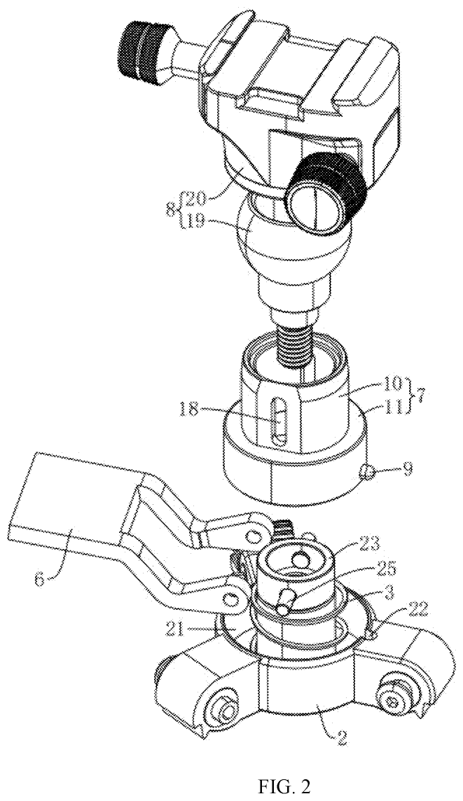

Referring to FIG. 2, in a specific embodiment, the tripod further comprises a torsion spring 3. An upright pillar 23 is fixed in the middle of the mounting slot 21, and the locking member 8 is fixedly connected to the upright pillar 23. The sliding member 7 is slidably fitted over the exterior of the upright pillar 23 in a vertical direction. The torsion spring 3 is fitted over the exterior of the upright pillar 23, and both ends of the torsion spring 3 abut against a bottom wall of the mounting slot 21 and the sliding member 7, respectively. The torsion spring 3 provides an elastic force and, at the same time, enhances the structural stability of the entire locking assembly 1 to a certain extent. Through its connection with the upright pillar 23, the bottom wall of the mounting slot 21, and the sliding member 7, the torsion spring 3 makes the connection among the components tighter, reduces shaking and looseness between components, and helps improve the overall durability and reliability of the tripod.

When the tripod is unlocked, and the driving member 6 presses the slide member 7 to slide downward, the torsion spring 3 undergoes elastic deformation. When the driving member 6 no longer presses the sliding member 7, the torsion spring 3 drives the sliding member 7 to reset upward by virtue of its elastic potential energy, such that the sliding member 7 abuts against and is retained at the bottom of the locking member 8, thereby achieving automatic reset and locking of the tripod. There is no need for a user to manually push the sliding member 7 back into place, which further improves ease of use and simplifies the entire operation procedure.

In a specific embodiment, the sliding member 7 includes an upper portion 10 and a boss portion 11 that are integrally formed. Sliding grooves 18 are formed through opposite sides of the upper portion 10, and connecting shafts 25 are protrudingly provided on both sides of the upright pillar 23 corresponding to the sliding grooves 18. The two connecting shafts 25 extend through the two sliding grooves 18, respectively. Each end of the driving member 6 is fitted over one of the connecting shafts 25, and the driving member 6 is rotatable about the connecting shafts 25. When the driving member 6 is pressed, a curved portion of the driving member 6 abuts against the boss portion 11.

Here, the sliding member 7 can slide accurately in a vertical direction along the connecting shafts 25 on the upright pillar 23 within the sliding grooves 18. The cooperative arrangement between the sliding grooves 18 and the connecting shafts 25 provides a guiding function, ensuring that the sliding member 7 moves only in the predetermined vertical direction and restricting its displacement in other directions, thereby ensuring the accuracy of the locking and unlocking actions of the tripod. At the same time, this cooperative arrangement increases the contact area between the sliding member 7 and the upright pillar 23, making the sliding process smoother and reducing shaking and jamming.

Each end of the driving member 6 is rotatably connected to one of the two connecting shafts 25. When the driving member 6 is pressed, its curved portion abuts against the boss portion 11, enabling the driving member 6 to effectively transmit an external force to the sliding member 7. The rotatable connection between the driving member 6 and the connecting shafts 25 provides a flexible rotational fulcrum for the driving member 6, allowing a user to operate the driving member 6 through a simple rotational action. The abutment between the curved portion of the driving member 6 and the boss portion 11 of the slide member 7 ensures that the force is accurately applied to the sliding member 7 when the driving member 6 is pressed, thereby pushing the sliding member 7 to slide downward in a vertical direction and unlocking the tripod. This connection and abutment arrangement makes the driving of the sliding member 7 by the driving member 6 more direct and efficient, and the user operation more convenient and labor-saving.

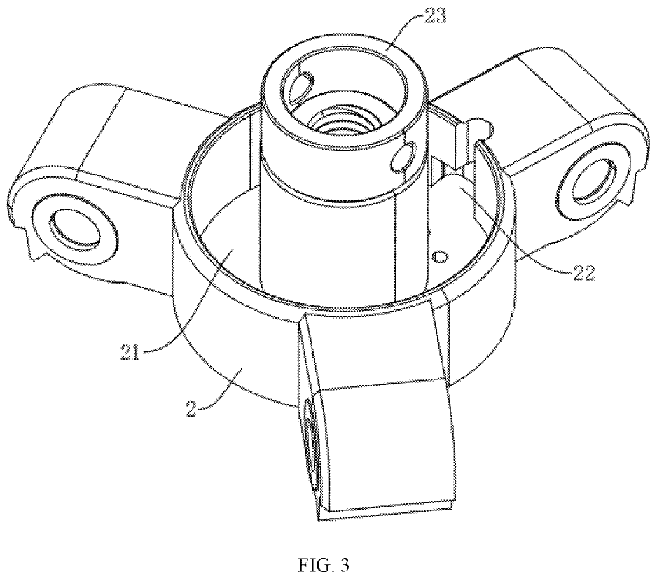

Referring to FIG. 2 and FIG. 3, in a specific embodiment, the limiting groove 22 is L-shaped, and the limiting structure 9 is protrudingly provided on an outer side wall of the boss portion 11. When the driving member 6 is pressed, the limiting structure 9 slides along a vertical end of the limiting groove 22 and is snap-engaged and retained at a horizontal end of the limiting groove 22.

The L-shaped limiting groove 22 cooperates with the limiting structure 9 on the outer side wall of the boss portion 11 to accurately define the position of the sliding member 7 when the tripod is unlocked. When the driving member 6 is pressed, the sliding member 7 drives the limiting structure 9 to first slide along the vertical end of the limiting groove 22. When the limiting structure 9 is snap-engaged at the horizontal end of the limiting groove 22, it indicates that the sliding member 7 has reached the accurate unlocking position, and the tripod is in a stable, unlocked state.

When the tripod needs to be locked, a user may rotate the driving member 6 horizontally. The driving member 6 drives the sliding member 7 to rotate horizontally, such that the limiting structure 9 slides from the horizontal end to the vertical end of the limiting groove 22, and slides upward, driven by the elastic potential energy of the torsion spring 3, until the top of the sliding member 7 abuts against and is retained at the bottom of the locking member 8, thereby locking the tripod. The sliding of the limiting structure 9 within the limiting groove 22 restricts the movement of the sliding member 7 in other unintended directions, enabling the tripod to maintain a stable state after being unlocked or locked without shaking or deforming under slight external forces, thus improving the stability and reliability of the tripod during use.

Further, the end of the limiting structure 9 away from the sliding member 7 is an arc surface. The arc surface design can make the sliding of the limiting structure 9 within the limiting groove 22 smoother and reduce jamming. Moreover, it enables a smoother snap-engagement action when the limiting structure 9 is snap-engaged at the horizontal end of the limiting groove 22. Similarly, the arc surface design facilitates the disengagement of the limiting structure 9 from the horizontal end of the limiting groove 22, lowers operating resistance, and makes the unlocking and locking processes of the tripod more convenient and smooth. There is a line contact or point contact between the arc surface and the limiting groove 22. Compared with planar contact, this produces less friction during sliding and snap-engagement, thereby effectively reducing wear between the limiting structure 9 and the limiting groove 22, and prolonging the service life of the limiting structure 9 and the limiting groove 22.

In a specific embodiment, the locking member 8 includes a ball 19 and a sleeve 20. The bottom end of the ball 19 extends through the sliding member 7 and is fixed in the upright pillar 23. The sleeve 20 is rotatably fitted over the exterior of the ball 19, and the top of the sliding member 7 is configured to abut against the bottom of the sleeve 20.

The sleeve 20 is rotatably fitted over the exterior of the ball 19, enabling the sleeve 20 to rotate flexibly relative to the ball 19. During use of the tripod, such rotational flexibility can adapt to different usage scenarios and angle adjustment requirements. For example, when the support angle of the tripod needs to be adjusted, the sleeve 20 can adapt to different positions through rotation, thereby better meeting the user's requirements for posture adjustment of the tripod.

The bottom end of the ball 19 extends through the sliding member 7 and is fixed in the upright pillar 23, ensuring stable mounting of the ball 19 on the upright pillar 23 and providing a firm foundation for the entire locking structure. The top of the sliding member 7 abuts against the bottom of the sleeve 20. When the sliding member 7 resets upward, its top tightly abuts against the bottom of the sleeve 20, so as to lock the sleeve 20, thereby restricting the movement of components associated with the sleeve 20 and achieving the purpose of locking the tripod. This design enables accurate locking and positioning, ensures the stability and reliability of the tripod in a locked state, and prevents the tripod from accidental unlocking or shaking.

### Embodiment 2

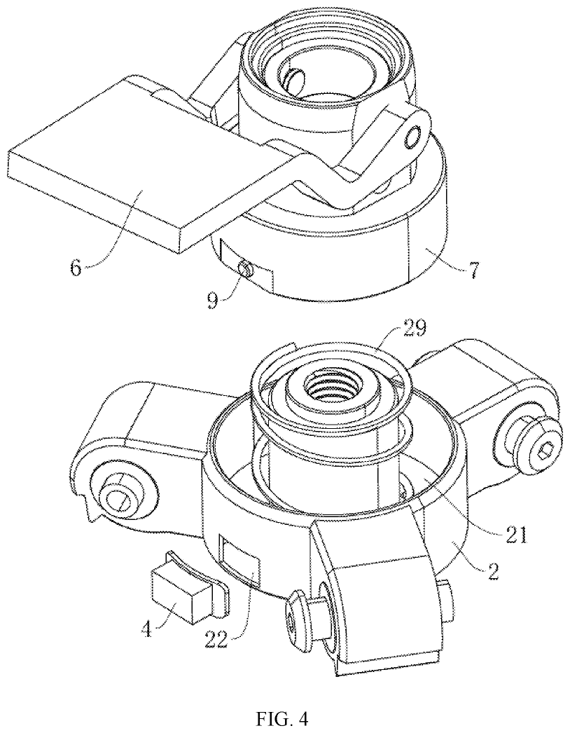

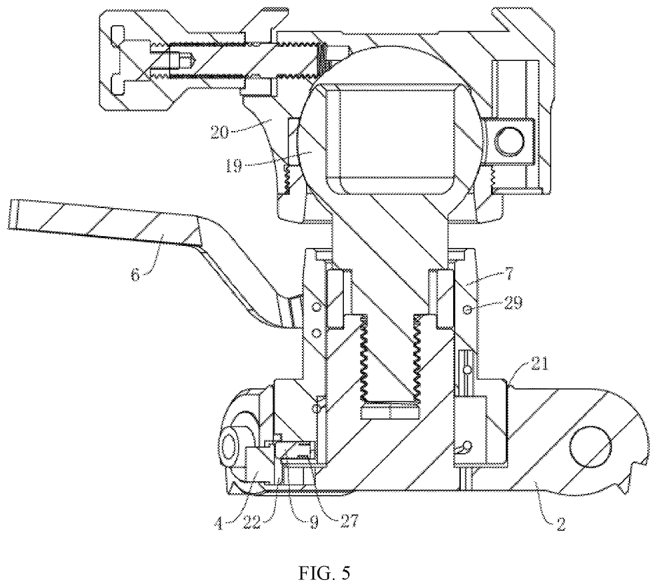

Referring to FIG. 4 and FIG. 5, this embodiment differs from Embodiment 1 mainly in that the tripod further includes a pressing member 4 and a first spring 29. Both ends of the first spring 29 abut against a bottom wall of the mounting slot 21 and the sliding member 7, respectively. The limiting groove 22 extends through a side wall of the mounting bracket 2, and the pressing member 4 is slidably retained in the limiting groove 22. A limiting structure 9 is horizontally slidably provided on a side wall of the boss portion 11. A second spring 27 is provided between the limiting structure 9 and the boss portion 11, and the pressing member 4 is configured to abut against the limiting structure 9.

When the tripod is in an unlocked state, the limiting structure 9 slides downward to the limiting groove 22 along with the slide member 7. Under the elastic force of the second spring 27, the limiting structure 9 is snap-engaged in the limiting groove 22 and abuts against the pressing member 4. When the tripod needs to be locked, a user may press the pressing member 4, such that the pressing member 4 pushes the limiting structure 9 to disengage from the limiting groove 22. At this time, the second spring 27 is compressed to store elastic potential energy, and the sliding member 7 slides upward, driven by the elastic potential energy of the first spring 29, until the top of the sliding member 7 abuts against and is retained at the bottom of the locking member 8, thereby locking the tripod. Here, the cooperative arrangement between the pressing member 4 and the limiting structure 9 simplifies the locking and unlocking steps of the tripod, and improves the working efficiency and the ease of use of the tripod.

### Embodiment 3

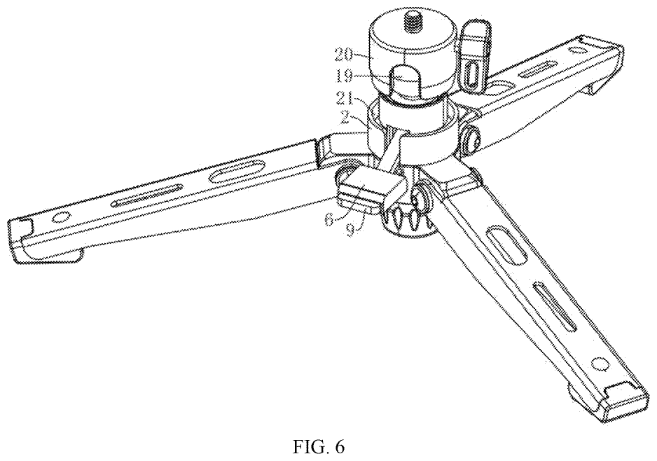

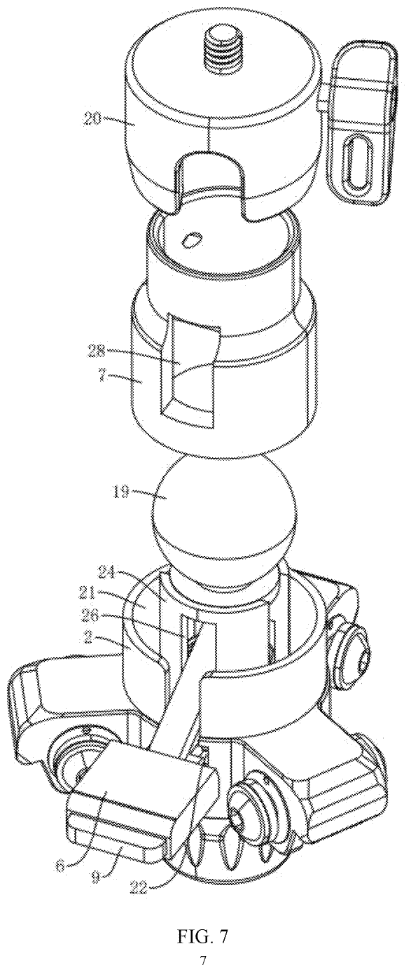

Referring to FIGS. 6 to 9, this embodiment differs from Embodiment 1 mainly in that a connecting post 24 is provided in the middle of the mounting slot 21, the locking member 8 is fixedly connected to the top of the connecting post 24, and the limiting groove 22 extends through a side wall of the mounting bracket 2. An abutment bar 12 is provided in the middle of the sliding member 7, and the abutment bar 12 extends through the middle of the connecting post 24. The tripod further includes a third spring 5, and both ends of the third spring 5 abut against the bottom of the abutment bar 12 and a bottom wall of the mounting slot 21, respectively. A first through slot 26 is formed through a side wall of the connecting post 24, and a second through slot 28 is formed through one side of the sliding member 7. The other end of the driving member 6 sequentially extends through the first through slot 26, the second through slot 28, and the limiting groove 22, and the driving member 6 abuts against the top of the abutment bar 12 to drive the sliding member 7 to slide. One end of the limiting structure 9 is movably retained in the limiting groove 22, and the other end of the limiting structure 9 is slidably connected to the driving member 6.

Here, the connecting post 24 provides a supporting and guiding function for the sliding member 7, enabling the sliding member 7 to slide stably in a vertical direction along the connecting post 24, thereby ensuring the accuracy of the locking and unlocking actions of the tripod. The abutment bar 12 extends through the middle of the connecting post 24 and cooperates with the driving member 6 and the third spring 5. The driving member 6 abuts against the top of the abutment bar 12. When pressed by a user, the driving member 6 can drive the sliding member 7 to slide downward via the abutment bar 12. At the same time, the abutment bar 12 also provides an action point for the third spring 5, enabling the third spring 5 to exert an upward elastic force on the sliding member 7 through the abutment bar 12. The first through slot 26 and the second through slot 28 provide a rotation space for one end of the driving member 6 and restrict the rotational space of the driving member 6, thereby enabling the driving member 6 to accurately contact the abutment bar 12 and drive it to move during rotation, and ensuring the stability and accuracy of the driving action of the driving member 6 on the sliding member 7.

One end of the limiting structure 9 is movably retained in the limiting groove 22, and the other end is slidably connected to the driving member 6. Such a connection arrangement enables the driving member 6 to synchronously drive the limiting structure 9 to rotate while rotating to drive the sliding member 7 to slide downward. When the tripod is unlocked, pressing the driving member 6 drives the limiting structure 9 to snap-engage in the limiting groove 22, so as to maintain the unlocked state of the tripod. When the tripod needs to be locked, pressing the end of the limiting structure 9 protruding from the driving member 6 pushes the limiting structure 9 to disengage from the limiting groove 22. The sliding member 7 resets upward under the action of the third spring 5, such that the sliding member 7 can smoothly abut upwardly against and be retained at the bottom of the locking member 8, thereby locking the tripod and ensuring accurate switching between the locked and unlocked states of the tripod.

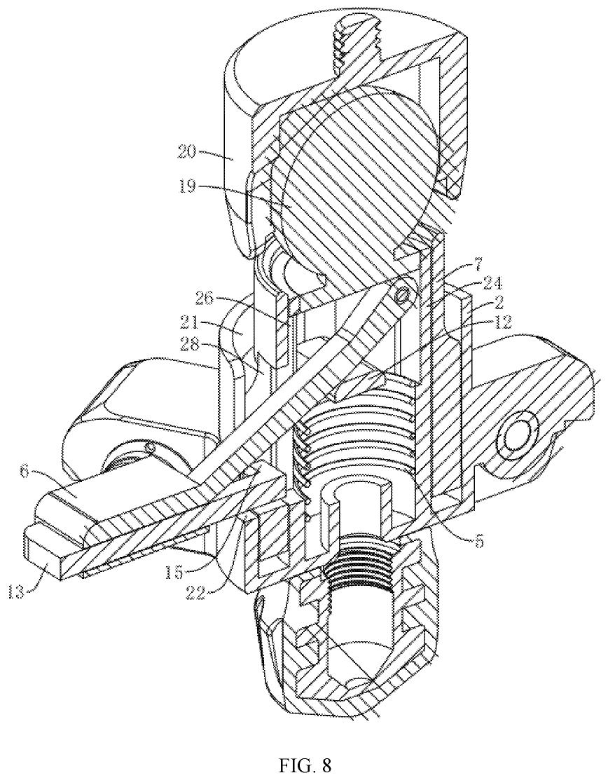

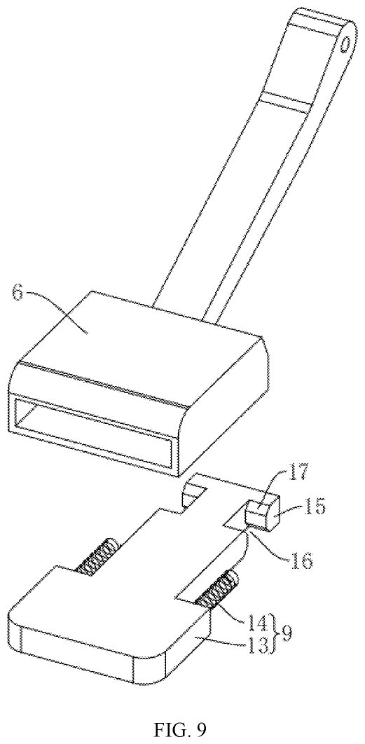

Referring to FIG. 8 and FIG. 9, in a specific embodiment, the limiting structure 9 includes a limiting block 13 and a fourth spring 14. One end of the limiting block 13 is provided with an I-shaped limiting portion 15 and a relief groove 16, and the limiting portion 15 is configured to abut against a groove wall of the limiting groove 22. The other end of the limiting block 13 slidably extends through the driving member 6. The fourth spring 14 is provided in the driving member 6, and both ends of the fourth spring 14 abut against the limiting block 13 and the driving member 6, respectively.

The limiting portion 15 at one end of the limiting block 13 can abut against the side wall of the limiting groove 22. When the tripod is in an unlocked state, the limiting portion 15 snaps into the limiting groove 22 and is in close contact with the side wall of the limiting groove 22. This structure can provide a large contact area and stable support, effectively restricting the position of the sliding member 7 and preventing it from moving accidentally, thereby ensuring that the tripod remains stable in the unlocked state. At this time, under the elastic action of the fourth spring 14, the other end of the limiting block 13 extends through and is retained at the end of the driving member 6 away from the connecting post 24.

When the tripod needs to be locked, a user may press the end of the limiting block 13 away from the limiting portion 15, thereby pushing the limiting portion 15 to disengage from the limiting groove 22. The sliding member 7 resets upward under the action of the third spring 5, such that the sliding member 7 abuts against and is retained at the bottom of the locking member 8, thereby locking the tripod. At this time, the relief groove 16 is located within the opening range of the limiting groove 22, and the relief groove 16 provides space for rotation of the limiting block 13, which reduces interference and jamming of the limiting block 13 during operation. This makes the locking and unlocking processes of the tripod smoother, improves the user's operating experience, and allows the user to switch the state of the tripod more easily.

Further, guide slopes 17 are provided on opposite sides of the limiting portion 15. During locking or unlocking operations of the tripod, the guide slopes 17 can provide guidance to achieve smoother contact between the limiting block 13 and the side wall of the limiting groove 22. When the limiting block 13 approaches the limiting groove 22, the guide slopes 17 can make it easier for the limiting block 13 to align with the limiting groove 22 and enable the limiting block 13 to enter the limiting groove 22 more smoothly, thereby improving the convenience and efficiency of operation.

The foregoing are merely specific embodiments of the present application, and are not intended to limit the scope of the present application. Any person skilled in the art may readily conceive various equivalent modifications or substitutions within the technical scope disclosed in the present application, and such modifications or substitutions shall be encompassed within the scope of the present application. Therefore, the scope of the present application shall be subject to the scope of the appended claims.

What is claimed is:

1. A portable unlocking tripod, comprising a locking assembly and a mounting bracket;
a mounting slot is provided at the top of the mounting bracket, and a limiting groove is provided in an inner side wall of the mounting slot;
the locking assembly comprises a driving member, a sliding member, and a locking member; one end of the driving member is rotatably connected to the mounting bracket, the sliding member is slidably fitted in the mounting slot, and a part of the driving member abuts against the sliding member so as to press the sliding member;
the locking member extends through the sliding member and is fixed in the mounting slot, and the sliding member is configured to lock the locking member;
a limiting structure is provided on the side of the sliding member, and when the tripod is in a locked state, the limiting structure is disengaged from the limiting groove; when the tripod is in an unlocked state, the limiting structure is snap-engaged and retained in the limiting groove.

2. The portable unlocking tripod according to claim 1, further comprising a torsion spring; an upright pillar is provided in the middle of the mounting slot, and the locking member is connected to the upright pillar; the sliding member is slidably fitted over the upright pillar in a vertical direction; the torsion spring is fitted over the exterior of the upright pillar, and both ends of the torsion spring abut against a bottom wall of the mounting slot and the sliding member, respectively.

3. The portable unlocking tripod according to claim 2, wherein the sliding member comprises an upper portion and a boss portion that are integrally formed, and sliding grooves are formed through opposite sides of the upper portion; connecting shafts are protrudingly provided on both sides of the upright pillar corresponding to the sliding grooves, and the two connecting shafts extend through the two sliding grooves, respectively; each end of the driving member is fitted over one of the connecting shafts, and the driving member is rotatable about the connecting shafts; when the driving member is pressed, the driving member abuts against the boss portion.

4. The portable unlocking tripod according to claim 3, wherein the limiting groove is L-shaped, and the limiting structure is protrudingly provided on an outer side wall of the boss portion; when the driving member is pressed, the limiting structure slides along a vertical end of the limiting groove and is snap-engaged and retained at a horizontal end of the limiting groove.

5. The portable unlocking tripod according to claim 2, wherein the locking member comprises a ball and a sleeve; a bottom end of the ball extends through the sliding member and is fixed in the upright pillar, the sleeve is rotatably fitted over the exterior of the ball, and the top of the sliding member is configured to abut against the bottom of the sleeve.

6. The portable unlocking tripod according to claim 1, further comprising a pressing member and a first spring; both ends of the first spring abut against a bottom wall of the mounting slot and the sliding member, respectively; the limiting groove extends through a side wall of the mounting bracket; the pressing member is slidably retained in the limiting groove; the limiting structure is horizontally slidably provided on a side wall of the sliding member; a second spring is provided between the limiting structure and the sliding member; and the pressing member is configured to abut against the limiting structure.

7. The portable unlocking tripod according to claim 1, wherein a connecting post is provided in the middle of the mounting slot, the locking member is fixedly connected to the connecting post, and the limiting groove extends through a side wall of the mounting bracket; an abutment bar is provided in the middle of the sliding member, and the abutment bar extends through the middle of the connecting post; the tripod further comprises a third spring, both ends of which abut against the bottom of the abutment bar and a bottom wall of the mounting slot, respectively; a first through slot is formed through a side wall of the connecting post, and one end of the driving member is rotatably connected to the connecting post; a second through slot is formed through one side of the sliding member, the other end of the driving member sequentially extends through the first through slot, the second through slot, and the limiting groove, and the driving member abuts against the top of the abutment bar to drive the sliding member to slide; one end of the limiting structure is movably retained in the limiting groove, and the other end of the limiting structure is slidably connected to the driving member.

8. The portable unlocking tripod according to claim 7, wherein the limiting structure comprises a limiting block and a fourth spring; one end of the limiting block is provided with an I-shaped limiting portion and a relief groove, and the limiting portion is configured to abut against a groove wall of the limiting groove; the other end of the limiting block slidably extends through the driving member; the fourth spring is provided in the driving member, and both ends of the fourth spring abut against the limiting block and the driving member, respectively.

9. The portable unlocking tripod according to claim 8, wherein guide slopes are provided on opposite sides of the limiting portion.
